(19) United States
(12) Patent Application Publication
(10) Pub. No.: US 2025/0297929 A1
(43) Pub. Date: Sep. 25, 2025

(54) SYSTEMS AND METHODS OF MATTER EXTRACTION FROM LUNAR SURFACE

(71) Applicant: Magna Petra Corp, Dover, DE (US)

(72) Inventors: Jeffrey Max, Hesperus, CO (US); Samuel Joseph Darling, Orange, CA (US); Hunter Forbes Williams, Nashville, TN (US)

(73) Assignee: Magna Petra Corp, Dover, DE (US)

(21) Appl. No.: 19/084,859

(22) Filed: Mar. 20, 2025

Related U.S. Application Data
(60) Provisional application No. 63/568,958, filed on Mar. 22, 2024.

(51) Int. Cl. G01N 1/22

(52) U.S. Cl. CPC G01N 1/2294; G01N 1/2205

(57) ABSTRACT

Aspects of the present invention relates to a lunar surface gas collection system designed to extract and collect gases and isotopes from the lunar regolith. The system may include an agitation system configured to disturb the lunar surface, generating a plume of matter that enters a molecular flow regime, thereby releasing gases and isotopes. A collection system may be provided to capture and direct these gases and isotopes to a secure collection area while preventing unwanted solid particles from entering the system.

### CROSS REFERENCE AND RELATED APPLICATIONS

This application claims the benefit of U.S. Provisional Patent Application No. 63/568,958, filed on Mar. 22, 2024, titled “SYSTEM, METHOD, AND APPARATUS FOR LUNAR GAS EXTRACTION”, which is hereby incorporated by reference in its entirety.

### BACKGROUND

Field of the Invention. Aspects of the present inventions relate to collection of matter from the surface of the moon or other celestial bodies. More particularly, embodiments of the present inventions relate to collection of gases and isotopes from the surface of the moon.

Background. The moon remains relatively unexplored when it comes to understanding its minerals, gases, isotopes and other matter that may be valuable for space exploration and resources for life on earth. For example, helium-three is viewed as a plentiful and valuable isotope that exists on the moon's surface; however, little has been done to collect it or make it available. There persists a need to understand how to identify and mine matter from the moon.

### SUMMARY OF THE INVENTIONS

The following summary is provided to introduce certain concepts of the invention in a simplified form. This summary is not intended to identify key or essential features of the invention, nor is it intended to be used to limit the scope of the invention. The invention is defined solely by the claims and their equivalents. The following description and accompanying drawings are provided for illustrative purposes and do not restrict the scope of the invention as set forth in the claims.

Aspects of the present invention relates to a lunar surface gas collection system designed to extract and collect gases and isotopes from the lunar regolith. The system may include an agitation system configured to disturb the lunar surface, generating a plume of matter that enters a molecular flow regime, thereby releasing gases and isotopes. A collection system may be provided to capture and direct these gases and isotopes to a secure collection area while preventing unwanted solid particles from entering the system.

To enhance efficiency, the collection system may incorporate a molecular directional change apparatus, such as a turbomolecular pump, which is configured to alter the momentum vector of the collected gases and isotopes to facilitate their movement toward the collection area.

In embodiments, a tortuous flow channel may be utilized to separate different gases and isotopes from the collected plume based on their molecular properties.

To minimize contamination from solid particles, a solids prevention mechanism may be employed, which may utilize an electrostatic charge system. In certain implementations, a positively charged mesh layer may be positioned over the collection system's inlet, repelling solid particles while allowing gases and isotopes to pass through. Multiple layers of mesh may be utilized, with at least one positioned to allow optimized gas flow.

In embodiments, the gas collection system may be configured to prevent the uncontrolled spread of collected gases and isotopes by directing them through a tortuous flow channel, ensuring efficient separation and capture. A gas and isotope purification detector may be included to analyze the composition of the collected gases at various points within the collection system.

Additionally, a gas composition analyzer may be provided to assess the collected gases and isotopes, enabling real-time data analysis for optimizing collection efficiency. Based on these measurements, an autonomous movement system may be configured to determine when the collection system should be relocated to a different area of the lunar surface to maximize gas production. Similarly, an autonomous agitation control system may be implemented to adjust the depth of agitation for increased gas and isotope extraction.

The invention may further comprise a networked system of multiple gas collection units distributed across different areas of the lunar surface. Each unit may be configured to collect gases and isotopes independently while transmitting real-time collection data to a central control system. The central control system may be programmed to analyze data trends across multiple locations and direct one or more collection units to move to areas with higher predicted collection efficiency. Each collection unit may be equipped with sensors capable of detecting various types of matter, including gases, solids, liquids, and surface structures.

In embodiments, one or more collection systems may function as scouts, identifying new mining opportunities beyond currently targeted areas. The system may also be integrated with space-based, lunar surface-based, or Earth-based detection systems to monitor the lunar environment and optimize gas collection operations accordingly.

Aspects of the present invention relates to gas collection systems designed to extract gases and isotopes from a collection surface, such as the lunar regolith. In embodiments, a dome gas collection device may be utilized, comprising a mechanical agitator configured to disturb the collection surface and release gaseous materials. A plurality of mesh filters, which may be selectively electrically charged, may be interposed between the mechanical agitator and turbomolecular pumps fluidly coupled to an interior chamber of the dome. These filters may serve to regulate the passage of gases while preventing the ingress of unwanted solid particulates.

In embodiments, the mesh filters may be negatively charged, bi-charged, or arranged in multiple layers to enhance separation efficiency. The mechanical agitator may include till blades, an auger, or a crusher, depending on the specific application requirements. The dome gas collection device may be movably supported by at least two wheels, which may be selectively powered to provide controlled locomotion over the surface.

A rover-based gas collection device may also be provided, incorporating a mechanical agitator and at least two mesh filters, which may be selectively electrically charged. The rover may be configured with at least four wheels for mobility and may include a chamber where a plurality of turbomolecular pumps is fluidly coupled to the effluent of the mechanical agitator. In embodiments, a photovoltaic power generation system may be included to provide energy to the gas collection components. Additionally, the rover may comprise multiple chambers, with a second mechanical agitator operating in a separate chamber to optimize collection efficiency.

In embodiments, a system may be provided that integrates a rover and a dome gas collection device, wherein the rover is mechanically coupled to the dome. Additional domes may also be included in the system, allowing a single rover to coordinate gas collection operations across multiple locations.

A standalone gas collection device may also be employed, comprising a mechanical agitator, at least one selectively electrically charged mesh filter, at least two wheels for surface engagement, and a gas collector fluidly coupled to an interior chamber. The mesh filter may be operationally interposed between the agitator and the gas collector to regulate gas flow and particle separation.

In embodiments, a heating element may be thermally coupled to the mechanical agitator to enhance gas release efficiency. Various heating methods may be utilized, including conduction heating, radiant heating, microwave heating, and ultraviolet heating. The heating element may include a coil, which may be configured to engage the collection surface directly. In embodiments, the heated coil may be dragged across the surface, stamped onto the surface, or incorporated into a multi-component agitator system with parallel rails leading additional agitator components.

By combining mechanical agitation, selective filtration, and controlled heating, these gas collection systems may be optimized for efficiently extracting and processing gases from a target surface. In embodiments, mobility, energy efficiency, and automated processing techniques may be incorporated to enhance performance and adaptability in various operational environments.

### BRIEF DESCRIPTION OF THE DRAWINGS

The accompanying drawings are provided to illustrate example embodiments of the invention and to aid in understanding its various features. The drawings are not necessarily to scale and are not intended to limit the scope of the invention in any way. Modifications, adaptations, and variations may be made to the illustrated embodiments without departing from the scope of the invention as set forth in the claims. The invention should be understood to encompass additional embodiments that may not be explicitly depicted but fall within the scope and spirit of the disclosed concepts.

FIG. 1 illustrates a collection system in accordance with the principles of the present inventions.

FIG. 2 illustrates a collection system in accordance with the principles of the present inventions.

FIG. 3 illustrates a collection system in accordance with the principles of the present inventions.

FIG. 4 illustrates a collection system in accordance with the principles of the present inventions.

FIG. 5 illustrates a collection system in accordance with the principles of the present inventions.

FIG. 6 illustrates a collection system in accordance with the principles of the present inventions.

FIG. 7 illustrates a collection system in accordance with the principles of the present inventions.

FIG. 8 illustrates a collection system in accordance with the principles of the present inventions.

FIG. 9 illustrates a collection system in accordance with the principles of the present inventions.

FIG. 10 illustrates a collection system in accordance with the principles of the present inventions.

FIG. 11 illustrates a collection system in accordance with the principles of the present inventions.

FIG. 12 illustrates a collection system in accordance with the principles of the present inventions.

FIG. 13 illustrates a collection system in accordance with the principles of the present inventions.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

Without limitation to any other aspect of the present disclosure, aspects of the disclosure herein provide for systems, apparatuses, and methods for extraction of isotopes and gases from lunar regolith. Various gases are believed to be embedded within the surface layers of the lunar regolith, for example including nitrogen, noble gases, and, depending upon the specific conditions, water. Certain ones of these gases are economically viable for utilization upon capture, for example for local utilization on the lunar surface, or extremely rare isotopes of gases such as 3He that may be economically viable for transport to Earth, between other celestial bodies, to a space station, etc. Embodiments herein may be suitable for other challenging environments such as resource collection on an asteroid or Mars.

Previously known or evaluated systems for recovery of lunar gases utilize thermal processes for gas sublimation and release, which require significant energy input in a challenging environment. Embodiments herein utilize mechanically based release and capture of gases of interest, which may be utilized as a sole gas recovery mechanism, and/or as a preliminary gas recovery mechanism which may be combined with other gas recovery operations.

The inventors recognized that while helium-3 (He-3) is present on the lunar surface, as well as on other celestial bodies exposed to solar winds—such as Mars and certain asteroids—existing extraction techniques are highly inefficient. Conventional methods require excessive energy, making them impractical for a sustainable mining operation in space. Additionally, many current systems incorporate complex mechanical components that are vulnerable to failure due to the abrasive nature of lunar regolith, which can infiltrate and jam moving parts.

Some traditional extraction approaches involve mining lunar regolith in a manner similar to terrestrial rock mining, followed by extensive processing to extract trapped gases. This process demands tremendous energy input, particularly for heating the material to temperatures exceeding 700° C. to release He-3 and other volatiles. On Earth, such energy-intensive procedures can be offset by abundant power sources, but on the Moon, where energy is scarce and solar power is intermittent, these high-temperature requirements present a significant operational challenge. Furthermore, excavation of subsurface materials requires substantial mechanical effort, further compounding the energy constraints in off-world environments.

The inventors also recognized a critical temporal limitation: helium-3 extraction must ideally be completed within a single lunar day—approximately 14 Earth days—before the onset of lunar night. The extreme cold of lunar nighttime can freeze extraction equipment, rendering it inoperable, while also cutting off solar energy as a power source. This constraint makes efficiency and speed in extraction paramount, not only to maximize yield but also to ensure the continued functionality of the mining system.

Another key realization by the inventors was that deep excavation may not be necessary to access substantial quantities of helium-3 and other valuable gases. The lunar surface is in a constant state of exposure to solar wind bombardment, leading to the accumulation of these gases within the topmost layers of regolith. This insight suggests that effective gas extraction could be achieved at or near the surface, avoiding the need for energy-intensive deep mining operations.

Building on these realizations, the inventors developed novel systems and methods for the efficient extraction and selective capture of helium-3 and other isotopes. Their innovations are designed for use not only on the Moon but also on Mars, asteroids, or other celestial bodies where these gases have potential applications. The extracted materials could serve critical functions in space-based operations or be transported back to Earth, where helium-3, in particular, holds promise for border security (nuclear contraband detection) and future energy applications.

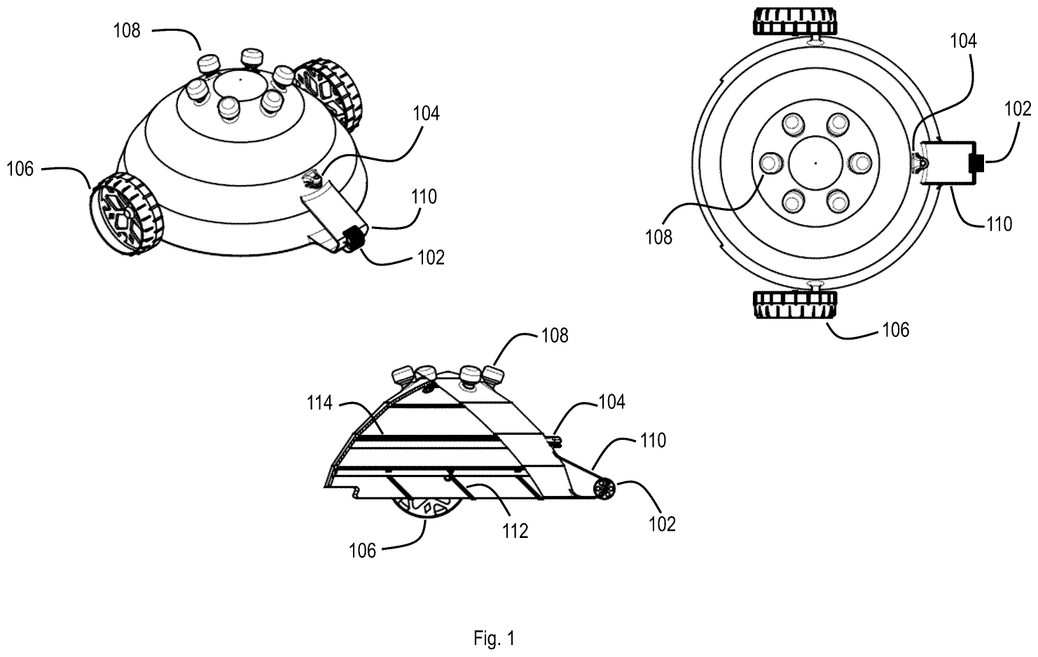

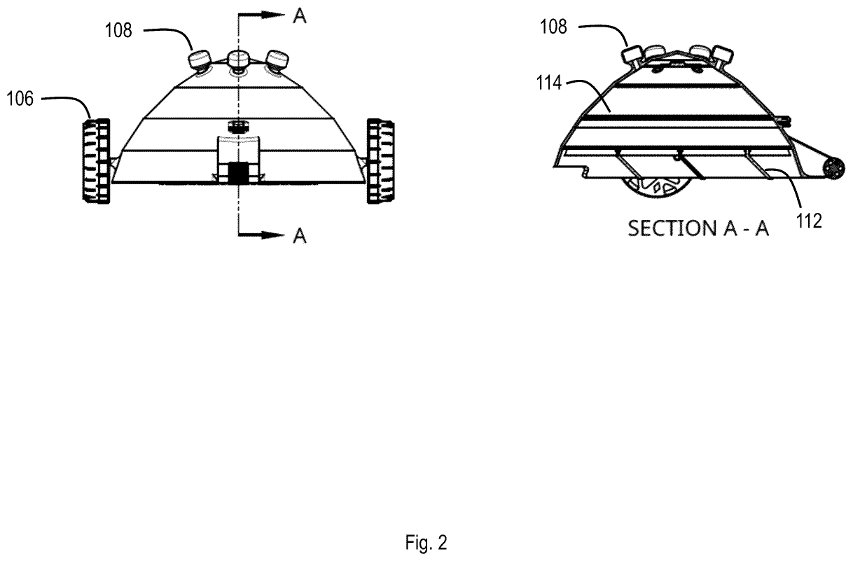

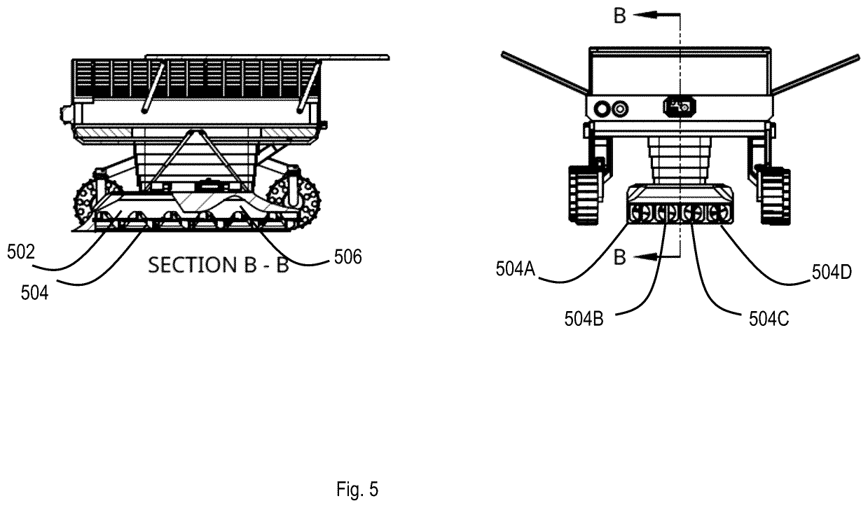

To provide additional context through examples, gas capture device examples are provided in two illustrative example form factors: a dome based device (e.g., FIGS. 1-4) and a rover device (e.g., FIGS. 5-8). It should be understood that there are many configurations that could be used as a collection device and these are provided merely for context and the inventions are not limited to these specific examples. Gas capture devices of the present disclosure are not limited to the form factors depicted, and systems herein are not limited to the number and type of devices depicted in the examples.

A collection device, system, or method in accordance with the principles of the present invention is designed to capture materials released above a surface following a disturbance—such as on the lunar surface or any other environment where these techniques may be beneficial. This collection system may also include sorting or filtration mechanisms to remove solids (e.g., lunar regolith), such that they do not need to be processed and allowing for the separation and secure capture of gases. Additionally, the system may be designed to further refine the collected gases, isolating specific isotopes or gases, such as helium-3, H₂, Xe, etc.

On the Moon, where gravity is weak and no atmosphere exists, regolith agitation—whether through mechanical vibration, electrostatic means, thermal processing, gas pressurization, or other method—causes trapped gases to be released into a free molecular flow regime. In this low-pressure environment, gas molecules are sparse and rarely collide with one another (unlike in Earth's atmosphere). Instead, they travel in straight lines until they interact with a surface. Meanwhile, heavier solid particles, like regolith grains, quickly fall back to the lunar surface under the Moon's weak gravity, allowing for a natural separation between gases and solids.

A collection device according to the present invention is designed to intercept and direct the released gases into a capture chamber. This may involve a reflective or guiding surface that redirects gas molecules toward a controlled collection area, where they can be processed and stored. Within the capture chamber, additional systems may be implemented to channel the gases efficiently. For instance, in some embodiments, a turbomolecular pump may be incorporated, utilizing rapidly spinning blades to impart momentum to the gas molecules. In the free molecular flow regime, the blades do not compress the gases as in traditional atmospheric systems but instead physically strike the molecules, directing them toward a funnel or conduit leading to a gas storage system.

Moreover, the collection system may be designed to separate gases based on their mass and velocity. Because lighter gases travel faster than heavier ones, the system may feature an elongated collection path or a tortuous flow channel, allowing for progressive separation. This ensures that by the time gases reach the final collection zone, the lightest gases, such as He-3, are preferentially concentrated, enabling a more efficient and selective capture process.

Embodiments may also have filters to help maintain cleanliness, avoid mechanical problems, and impede or eliminate materials from entering the collection system. For example, a collection system may have an electrostatic repellent system at or near the entrance of the gas collection chamber to prevent lunar regolith from contaminating the extracted gases while allowing the free flow of valuable isotopes such as helium-3. Due to continuous exposure to solar wind, lunar dust particles become electrically charged, typically acquiring a positive charge on the sunlit side of the Moon. This charge characteristic presents a unique opportunity to use electrostatic forces to repel regolith particles away from the gas collection system, enabling an efficient and contamination-free extraction process.

The collection process may begin with the disturbance of the lunar surface, releasing trapped gases from the regolith. As these gases enter a free molecular flow regime, heavier solid particles quickly settle back to the surface under lunar gravity, while gases remain in motion. However, some fine regolith particles may remain suspended and could enter the collection chamber, potentially clogging and damaging components or interfering with gas separation. To address this, the systems in accordance with the principles of the present inventions may incorporate a charged electrode grid or electrostatic field at the entrance of the collection chamber. By applying a strong positive charge, the system repels similarly charged regolith particles, preventing them from passing through while allowing neutral gas molecules to continue into the chamber.

To further enhance dust mitigation, the system may employ oscillating electrostatic fields to create a dynamic repulsion effect, continuously pushing dust particles away from the intake area. Additionally, strategically placed parallel plates or charged surfaces generate an electrostatic force field that further deflects lunar dust without requiring physical barriers, reducing mechanical wear and the risk of clogging. This helps ensure that only the desired gases, including helium-3, hydrogen, and other volatiles, are captured while the abrasive lunar dust remains outside the collection system.

This electrostatic repulsion technique may significantly improve the efficiency and longevity of the gas collection system. Unlike mechanical filtration methods, which can degrade over time due to regolith abrasion, the electrostatic system provides a low-energy, contactless solution that can function reliably in the harsh lunar environment. The ability to selectively filter out regolith while preserving gas collection efficiency makes this approach particularly well-suited for long-term lunar operations, whether for in-situ resource utilization (ISRU) or helium-3 extraction for energy applications on Earth.

Example descriptions to the basic form factors are provided for illustration of aspects of the present disclosure. A given system may include a single dome, a single rover, more than one dome, more than one rover, integration within new or existing rovers/vehicles, stagnant devices/infrastructure or combinations of these. In certain embodiments, the form factor for the dome may include any enclosed or partially enclosed vessel, which allows for the collection of gases and/or isotopes. Example and non-limiting form factors include an elongated form (e.g., to allow for extended residence time for till action or a tumbler), a semi-cylinder, ellipse, rectangular solid, or the like.

Referencing FIG. 1, an example dome gas capture device is schematically depicted. The example dome includes wheels 106 that allow traversal on the lunar surface, for example rolling on the lunar soil (e.g., lunar regolith), and engaging till blades with the regolith, lifting and agitating regolith. Such a system may be pulled, pushed, self-propelled, stationary, or integrated in/integral to other vehicles. For example, a collection system may be integrated into/integral to an industrial scale lunar mobility vehicles, such as the Toyota® Lunar Cruiser. The mechanical agitation of the regolith releases embedded gases therein, which are captured within the dome. In the example of FIG. 1, turbomolecular pumps 108 are distributed within the dome, that capture and redirect isotopes and gasses released through the mechanical agitation of the regolith. Gas capture may additionally or alternatively be captured utilizing any technique, for example adsorption of the gases on a suitable material bed. The captured gas may be stored, for example, into small (or suitably sized) tanks coupled to the turbomolecular pumps. Example and non-limiting collection operations include capture by cooling or condensing gases, charged particle collection, and/or utilization of an adsorbent. In certain embodiments, gas collection may be completed by recovery of the storage tanks, for example with total recovery of the dome, and/or with swapping out the tanks with new, empty tanks (and/or tanks having collection capacity available, and/or tanks prepared for collection operations). In certain embodiments, the tanks may be swapped out, with the filled tanks returned to a lunar facility or to Earth, and with the dome ready to be returned to collection service once empty tanks are installed.

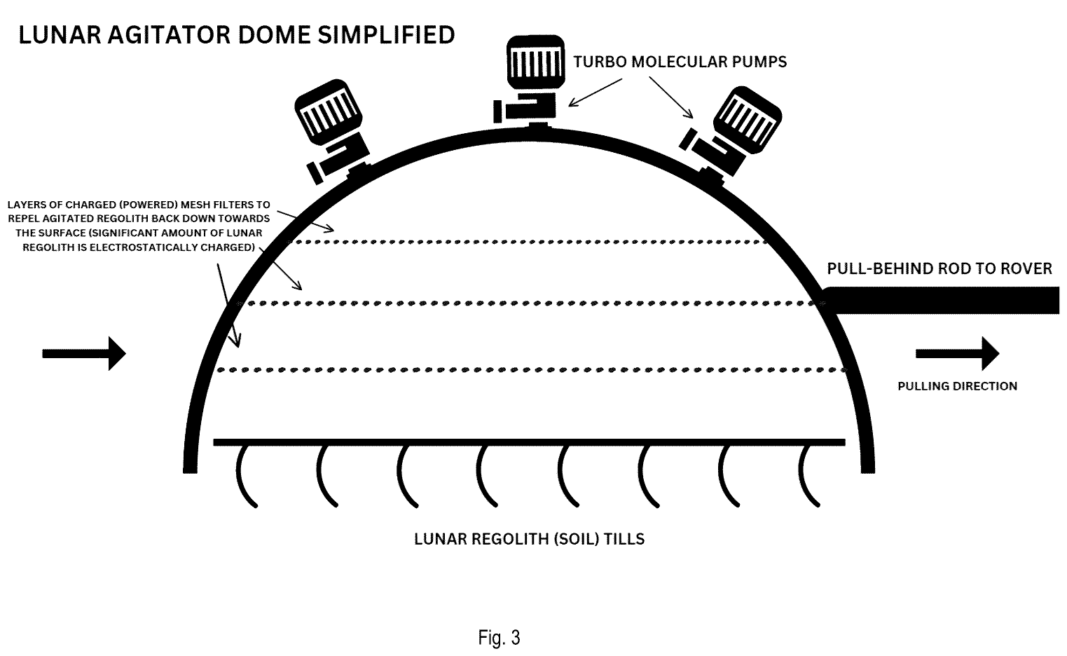

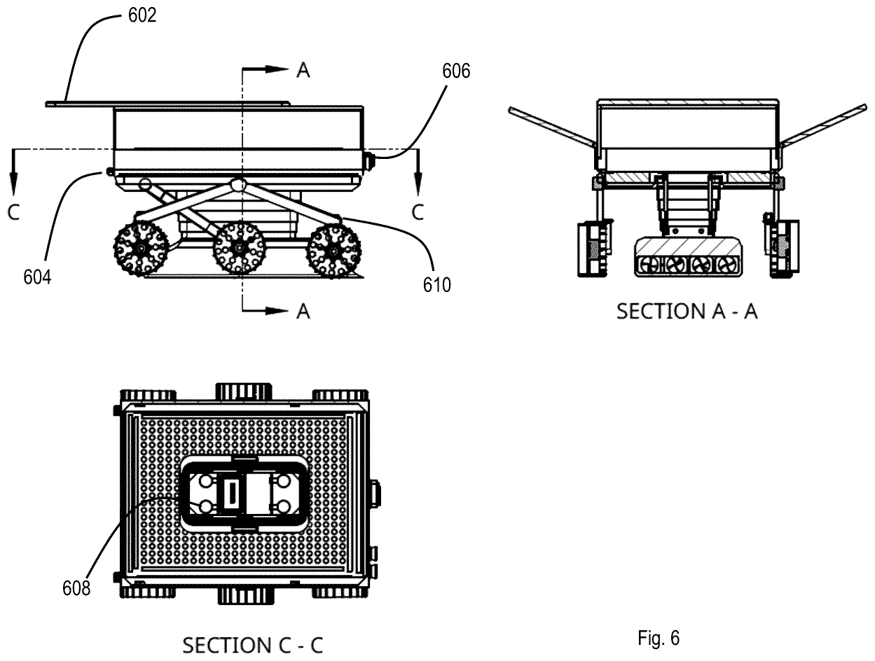

The example till blades 112 may be presented at any angle, and may be straight blades (e.g., reference FIG. 1) or curved blades (e.g., reference FIG. 3). In certain embodiments, the till blades 112 may be fixed or mobile. Where the blades are mobile, they may be discretely controlled (e.g., moved between one of several discrete angle options) or continuously controlled (e.g., moved to a selected angle using a motor or other actuator). In certain embodiments, blade angle adjustments may be utilized to control agitation or engagement depth with the regolith, to respond to the environment or characteristics of the local regolith, and/or according to the available motive power for the dome (e.g., to reduce motive power requirements according to available power, battery charge, or the like). In certain embodiments, blade angle adjustments may be utilized to adjust the agitation depth according to the characteristics of the regolith (e.g., the depth trajectory of the concentration of embedded gases in the specific region and conditions), and/or according to the operating condition of the gas collection device, for example to reduce the motive power requirements to move the dome when traveling between collection locations and/or when returning to a lunar facility. In certain embodiments, the blade engagement depth may also be selected or controlled, for example by raising or lowering one or more of the blades, and/or by raising or lowering the dome body (e.g., using an actuator controlling the coupling depth of the wheels and dome body, similar to the example of FIG. 6 for the rover device). In certain embodiments, the blade depths and/or angles may be varied between blades, for example with rearward blades having a greater depth than forward blades.

The example till blades 112 are one example of a mechanical agitation device that may be utilized in the dome and/or rover devices. In certain embodiments, other mechanical agitation devices may be utilized, in addition to or as an alternative to, the till blades 112. Example and non-limiting mechanical agitation devices include augurs/screws, scoops (and/or rotating scoops, which may rotate parallel to, perpendicular to, and/or obliquely to the direction of travel of the dome and/or rover), punchers, and/or discs. In certain embodiments, mechanical agitation devices may further include devices to break up, crush, and/or shake the agitated regolith, and which may be performed as a part of the agitation of the regolith and/or performed on lifted regolith (e.g., within the body of the dome and/or rover, for example above the till blades or other mechanical agitation device).

The example dome includes a front support, including a bracket 110 and support wheel 102 in the example of FIG. 1. The front support is optional, and may be positioned at any location to cooperate with the wheels 106 and thereby support the dome (e.g., where the center of gravity of the dome is positioned within the boundary of the wheels 106 and front support). In certain embodiments, the dome may additionally or alternatively include additional wheels providing the overall support for the dome. In certain embodiments, the dome is coupled to a towing device, for example where the dome is towed behind another dome and/or a rover, coupled to a towing bracket 104 in the example of FIG. 1. Where the towing bracket 104 is present, the front support may be present or omitted. In certain embodiments, the inclusion of a front support (or other stabilizing support, such as a support at another location and/or the presence of additional wheels 106), even where the dome is typically moved through towing, allows for the dome to be supported during various operating conditions, while de-coupled from the towing device, and/or allows the dome to traverse obstacles or obstructions more easily.

In certain embodiments, the wheels 106 may be passive and allow the dome to be towed or otherwise moved by an external device. In certain embodiments, the wheels 106 may be powered, and/or may be individually controlled. Where the wheels 106 are powered, the powering of the wheels 106 may be utilized to provide primary motive power and/or to provide power to perform and/or improve certain operations, such as enhancing steering operations, movement during offloading of collected gas, coupling or de-coupling to towing devices, maneuvering around obstacles, or the like. In certain embodiments, power to the wheels 106, where present, may be provided onboard (e.g., from solar panels, a radioactive battery, a rechargeable battery, etc.) and/or may be provided externally (e.g., coupling a tether when the dome is in proximity to an offloading facility). Any one or more wheels of any collector, for example a dome or rover, as set forth throughout the present disclosure, may be passive wheels and/or powered wheels.

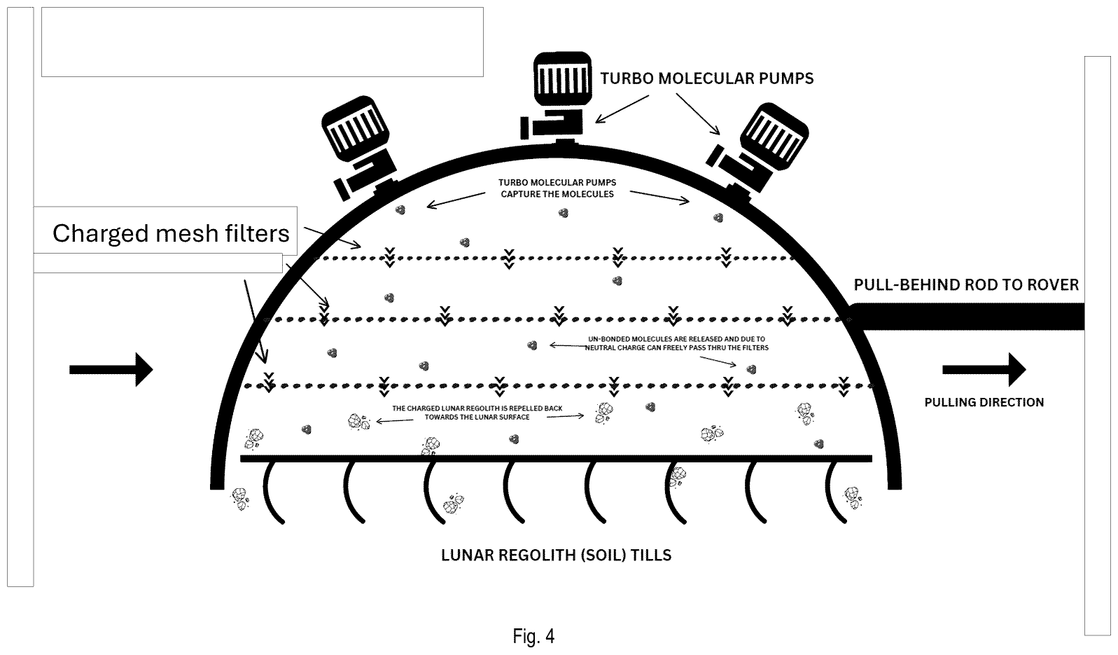

The example dome includes at least two meshes configured to perform coarse filtering operations for the regolith, allowing larger regolith particulates to settle out of the dome and collecting gases on the sides or top of the dome with the gas collection devices. In certain embodiments, one or more of the mesh filters (or all of the mesh filters) may be charged, which may include using charge pulses, charge trajectories, charge gradients, or the like, to manage rejection of the regolith (typically positively charged) while allowing neutral gases to pass freely therethrough. The charges may be single sided (e.g., a positive charge on the lower side of a given mesh) or double sided (e.g., a negative charge on the upper side of the given mesh), and the charges on the meshes may be sequenced, for example to keep the meshes clear of regolith. In certain operations, for example during cleaning and/or recovery of the dome between collection operations, other charges and/or charge sequences may be utilized (e.g., positive charge on the upper side to encourage clearing of the mesh). In certain embodiments, arrangements of the mesh openings may be further configured to encourage rejection of the regolith, for example utilizing mesh patterns, making it less likely that regolith will succeed in passing to an upper gas collection chamber. Referencing FIG. 3, a non-limiting example of charged mesh filter layers are schematically depicted. Referencing FIG. 4, an example consistent with FIG. 3 schematically depicts regolith repelled back to the surface, with uncharged gases released through agitation freely passing through the mesh filters to be collected.

Referencing FIG. 5, an example gas collection device includes a rover having a number of wheels configured to motively power the rover over the lunar surface. The example rover includes an agitation payload that lifts and agitates a layer of the regolith as it passes over the lunar surface. The example rover includes a sufficient longitudinal extent, and sufficient width, to allow for more than one agitation and collection mechanism to be defined therein. The example rover allows for gaseous collection operations, as well as allows for different gas collection techniques and configurations to be implemented, tested, and/or iteratively improved over time and/or over collection missions. Accordingly, embodiments utilizing the rover can more rapidly converge on successful collection techniques, and tune collection configurations for new areas, regolith composition variations, and/or gaseous product distributions and/or migration in the regolith. Additionally or alternatively, the rover provides sufficient space for power generation (e.g., utilizing solar panels and/or storage in the examples of FIGS. 5 and 6), and sufficient motive power to tow additional collection devices, for example a dome device or another rover device. The agitation payload may be raised or lowered below the body of the rover, and/or the wheel lift mechanism of the rover may allow for the body of the rover to be raised or lowered, adjusting the engagement depth of the agitation payload with the regolith.

In the example of FIG. 5, the rover includes two separated chambers 502, 506 in the space above an agitator 504 (an auger, in the example of FIG. 5), that allows for differential treatment of the released gas from agitation in the two chambers 502, 506, for example with distinct configurations and/or equipment for mesh filtering, molecular collection, or the like. In the example of FIG. 5, the separate chambers 502, 506 are differentiated longitudinally, but may additionally or alternatively be differentiated across the width of the rover. For example, a first chamber above augurs 504A, 504B may have differential collection characteristics (e.g., mesh sizes, number of meshes, mesh charges and/or charge trajectories, etc., and/or distinct molecular collection devices) relative to a second chamber above augurs 504C, 504D. In certain embodiments, a rover may utilize, in whole or part, a different mechanical agitation mechanism, such as till blades. The example of FIG. 5 is non-limiting, and a rover may include just a single chamber, or more than two chambers, and the chambers may be exposed to different agitators 504, and/or with more than one agitator 504 exposed to a single chamber.

Referencing FIG. 6, an example rover consistent with the example depicted in FIG. 5 is schematically depicted. The example rover includes photovoltaic power generation materials 602, a tow coupling mount 604, and/or navigation sensors 606 (e.g., a camera). A cutaway view depicts turbomolecular pumps 608, which may be accessible for changing, service, gas offloading, or the like. In certain embodiments, the wheel suspension 610 may be configured to adjust the height of the rover body, utilizing a scissor mechanism in the example, although any active suspension system may be utilized, for example where active control of the rover body height is desirable. The example rover depicts six wheels as a non-limiting example.

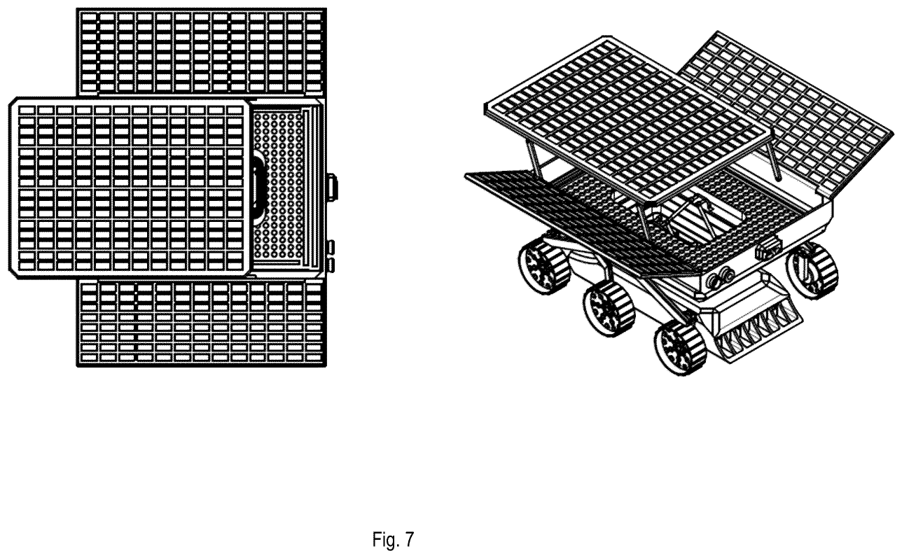

Referencing FIG. 7, an example rover, consistent with the examples of FIGS. 5 and 6, is schematically depicted in a top view and a perspective view. The example rover is depicted with the solar panels in a deployed position, for example utilized during charging and/or motive power operations. In certain embodiments, the rover may additionally or alternatively be powered with a fuel cell, radioactive battery, rechargeable battery, or the like. In certain embodiments, the rover may be powered, at least partially, utilizing a tether, plug-in, or wireless power transfer at a facility, for example a home base, gas offloading facility, and/or service/maintenance facility.

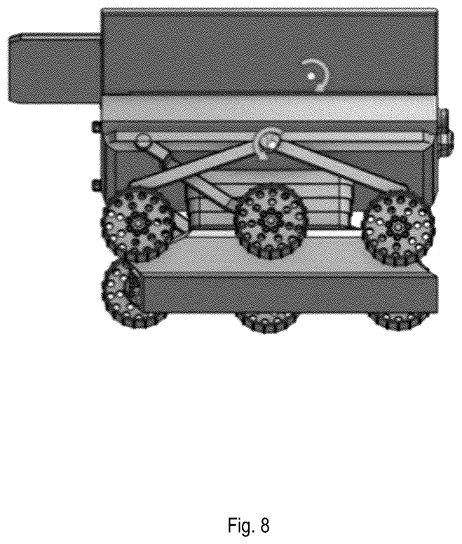

Referencing FIG. 8, an example rover, consistent with the examples of FIGS. 5-7, depicts actuating operations to adjust the rover body height, and/or to deploy or store the solar panels (where present).

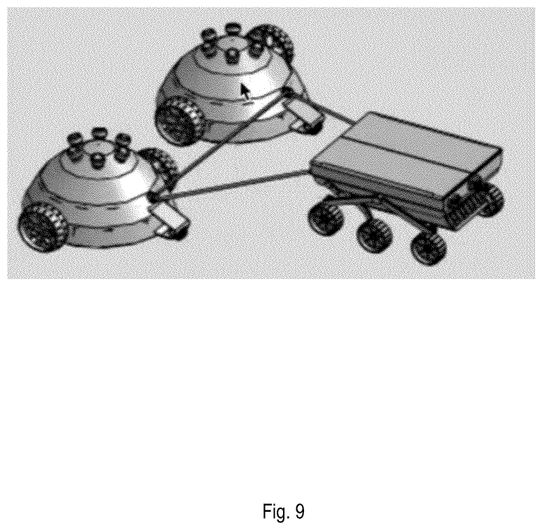

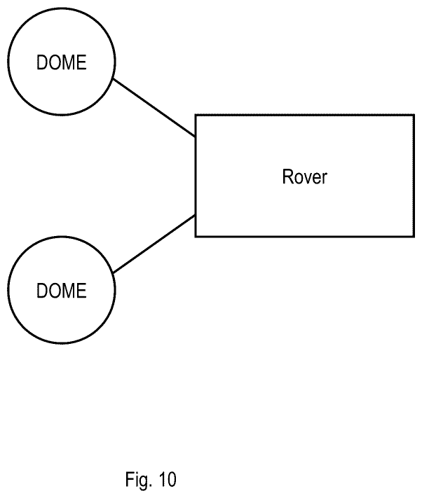

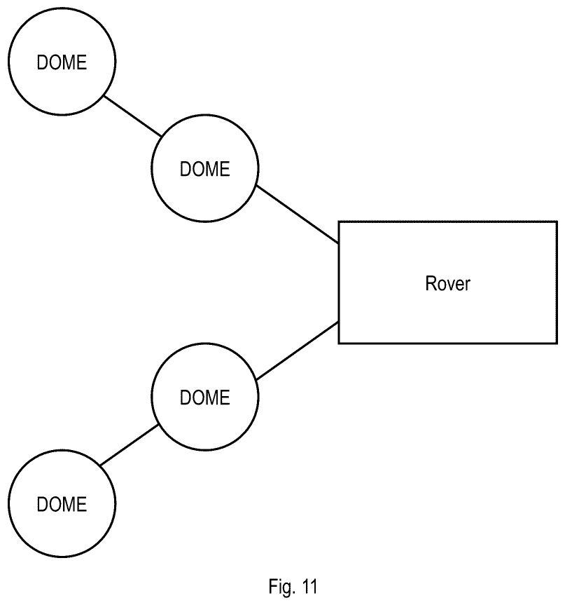

Referencing FIG. 9, an example rover, consistent with the examples of FIGS. 5-8, is schematically depicted in a towing arrangement with two towed domes. The domes in the example of FIG. 9 are consistent with example domes depicted in FIGS. 1-4. The example of FIG. 9 may be a collection system configured to collect entrapped gases from regolith with a path width from the first dome mechanical agitator across to the second dome mechanical agitator. The towing couplings may be rigid (e.g., rods) or flexible (e.g., cables), depending upon the paths to be traversed, availability of independent motive operation of the domes, or the like. In certain embodiments, one or both of the domes may be replaced with a rover, which may be configured the same as, or distinctly from, the lead towing rover. The specific number and arrangement of devices in a collection system are not limited to those depicted. Referencing FIG. 10, an example collection system includes a rover towing two domes. Referencing FIG. 11, an example collection system includes a rover towing four domes. The devices depicted in FIGS. 9-11 are arranged to each collect on a distinct path perpendicular to the direction of travel of the lead rover. Additionally or alternatively, different collection devices may travel, at least partially, on a same collection path, for example with a trailing collection device utilizing a different collection mechanism (e.g., a till blade leading device, with an auguring trailing device), and/or may be configured to mechanically agitate the regolith at a different depth of engagement (e.g., a trailing device engaging at a greater depth than the leading device).

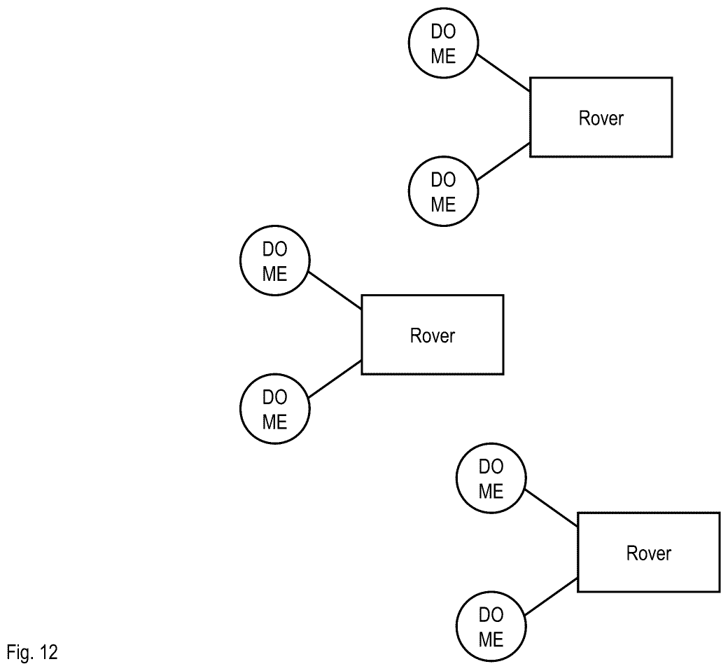

In certain embodiments, a number of collection systems and/or devices may operate in a swarm, for example traversing an area and cooperating to collect entrapped gases over the area. For example, referencing FIG. 12, three collection systems are depicted that traverse an area, collecting entrapped gases from the entire width across all three collection systems. In certain embodiments, collection systems operating together may be independently controlled to cover an area, for example with each traversing an area of responsibility, individually controlled by a central controller that tracks overall collection operations, or the like.

In certain embodiments, the composition and/or amount (e.g., mass, moles, or the like) of collected gases is tracked. For example, tracking of the collected gases may be utilized for iterative improvements to operations (e.g., comparing power utilization, capital expenditures, etc., utilized for each unit of commercially valuable gas collected), to determine utilization of collection devices, and/or to schedule certain operations (e.g., offloading, shipping, service, maintenance, etc.). The determination of the composition and/or amount of collected gases may be made by any method by any information available to the system, for example and without limitation determining the mass of collection tanks, pressure therein, thermal and/or electrical conductivity of fluid therein, acoustic properties of the fluid therein, or the like. In certain embodiments, composition of gases may be determined from optical determinations (e.g., peak detection within the dome space, and/or within the gas storage tanks), utilizing gas chromatography, and/or spectroscopy on ionized molecules from the collected gas. Mass determinations may be made by any known technique, including utilization of scales, vibration or acceleration testing, or the like. The described examples are non-limiting and provided to illustrate certain aspects of the present disclosure.

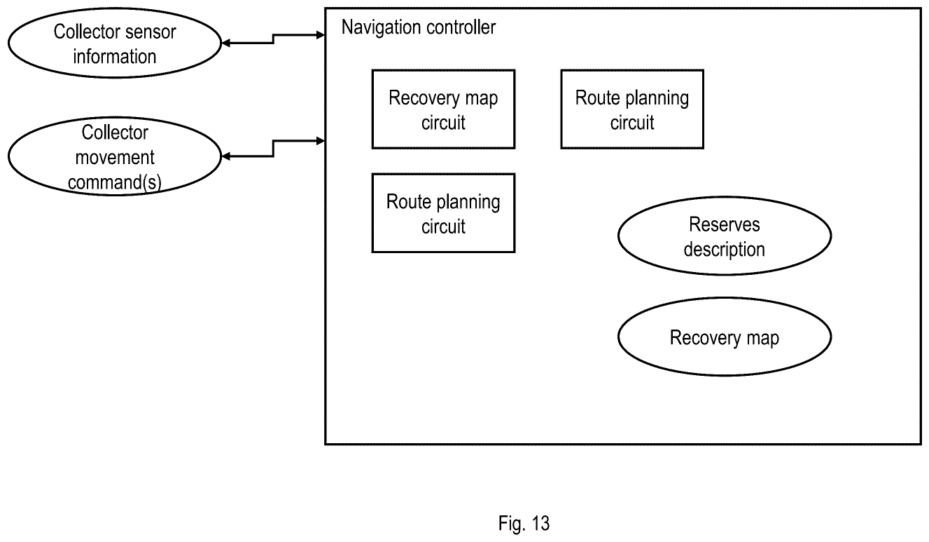

Referencing FIG. 13, an example navigation controller is depicted that provides for improved resource extraction by reducing redundant travel on the regolith through areas where a collector (e.g., a rover, dome, and/or a group of these such as set forth throughout the present disclosure) has already operated, and/or by ensuring complete coverage of collection for a given area. The example navigation controller may be embodied, in whole or part, on a controller positioned on the collector, at a base station at least intermittently in communication with a controller on the collector, and/or on an external controller at least intermittently in communication with the collector and/or a base station (e.g., a satellite based controller, which may be a lunar satellite or an Earth satellite, and/or a ground station on Earth, and/or on a cloud server on Earth, etc.). In certain embodiments, one or more aspects of the navigation controller may be distributed across any one or more, or all of these devices. The example navigation controller includes a number of circuits structured to functionally execute operations performed by the controller. A circuit may be embodied as instructions stored on a computer readable medium which, upon execution by a processor, perform one or more operations of the controller. In certain embodiments, a circuit may include one or more hardware aspects, such as a sensor of any type, an actuator of any type, an I/O or communication device, a programmable logic circuit, and/or any hardware aspect configured to respond to stimuli and/or the environment to perform one or more operations of the controller. In certain embodiments, a circuit may be embodied as first arrangement of instructions and/or hardware components at a first time (and/or at a first operating condition, and/or for a first operation), and embodied as a second arrangement of instructions and/or hardware components at a second time (and/or at a second operating condition, and/or for a second operation).

The example navigation controller includes a recovery map circuit structured to determine a recovery map including a region of the regolith where collector(s) have operatively traversed the surface performing collection operations. The example recovery map circuit includes a description of the area of interest, for example utilizing referential coordinates relative to a base station, using a “lunar GPS” paradigm, and/or according to any other reference system available. The example recovery map circuit may include a description of non-recovery areas within the area of interest, for example due to obstacles, infrastructure, contractual obligations, or the like. The example recovery map circuit may include a description of depleted areas, or areas where a collector has operatively traversed the surface performing collection operations (e.g., a collector has traversed the region with an agitator engaged with the surface). The example recovery map circuit may include a description of available recovery areas, for example areas where it is expected that a collector operatively traversing the area performing collection operations would be expected to recover gases and/or isotopes of interest as set forth throughout the present disclosure. In certain embodiments, the descriptions of the various areas may be combined and/or displayed to depict a recovery map, and/or utilized to determine routing of a deployed collector that will minimize over travel through already collected regions, and/or utilized to determine routing for a new collection operation that will maximize coverage of new area for the collection operation. In certain embodiments, utilization of power for the collector, minimization of wear and tear on the collector, and/or avoidance of obstacles or uncertain areas of travel, are at a premium due to the challenges of the lunar environment. In certain embodiments, the navigation controller monitors sensor values from the collector to determine the travelled path and/or current location of the collector. Such sensors include, without limitation, a LiDAR signal, a high resolution radar, a camera, a wheel encoder on the collector, an accelerometer, a gyroscope, a lunar GPS signal, and/or a line of sight range finder. In certain embodiments, sensors utilized to determine the position and/or travel path of the collector are positioned on the collector, positioned on or in proximity to the base station, and/or positioned on other devices such as a lunar satellite and/or a drone (e.g., a rocket or ion powered drone, and/or a crawling, walking, or rolling drone-for example one that does not tend to disturb the regolith in a manner that would affect expected recovery of later collection operations).

In certain embodiments, the navigation controller determines the sensor values in real time to track and determine the position and path of the collector. In certain embodiments, the navigation controller collects sensor information periodically and/or episodically (e.g., once a minute, once an hour, each time the collector “docks” back with the base station, etc.) from the collector. In certain embodiments, the navigation controller is positioned, at least partially, on the collector.

The example navigation controller includes a route planning circuit that determines a route for the collector. In certain embodiments, the route is an entire collection path, for example travelling to a collection initiation position, travelling through collection motions over an area, and/or travelling back to the base station or other collection, recovery, and/or charging area for the collector. In certain embodiments, the route includes travel instructions, such as raising or engaging an agitator device at certain positions (e.g., to avoid disturbing the regolith in certain regions, to reduce power consumption during travel, and/or to reduce wear on components of the collector), velocity parameters during travel, or the like. In certain embodiments, the beginning and ending positions during collection operations are selected to allow for coverage of the selected area, and to minimize negative effects (e.g., power consumption, travel over collected regions, and/or disturbance of uncollected regions) from travel operations for the collection. In certain embodiments, collection operations are monitored, for example allowing the navigation controller to determine whether collection was performed in the selected region, whether any areas were missed, and/or whether any off-nominal conditions (e.g., a failed agitator, collection pump, etc.) were experienced.

The example navigation controller may be configured to determine a recovery map, including for example a display of regions that have been collected, that remain uncollected, and/or providing an indication of collection parameters for regions (e.g., mass collected, motive power utilized, obstacles encountered, etc.). In certain embodiments, the navigation controller determines a reserve description—for example depicted amounts collected for various regions, reserves estimated to be in place for an area of interest (e.g., including feedback information from past collection performance), or the like. The example navigation controller provides movement commands to the collector, which may be provided as real-time commands (e.g., position values, velocity, motive commands, agitator commands, etc.), and/or which may be provided as a single command (e.g., routing instructions, a coverage region, etc.).

Without limitation to any other aspect of the present disclosure, methodologies, systems, and apparatuses for the extraction of gases and isotopes embedded within regolith on extraterrestrial bodies through mechanical disturbance means are encompassed herein. All embodiments, variations, and applications of mechanically-based release and capture of gases of interest through agitation, disruption, manipulation, and/or disturbance of regolith material are disclosed. These methodologies may be employed as a sole gas recovery mechanism and/or as a preliminary or supplementary gas recovery mechanism combined with other gas recovery operations.

### Mechanical Agitation for Gas Collection

In certain embodiments, methods of gas collection wherein mechanical agitation of regolith serves as the primary mechanism for liberating embedded gases and/or isotopes are covered. Such mechanical agitation includes, but is not limited to, tilling, auguring, crushing, grinding, sieving, vibrating, tumbling, piercing, stamping, raking, scraping, impacting, compressing, decompressing, shearing, or otherwise mechanically disturbing regolith material to release gases and/or isotopes contained therein. The use of such mechanical disturbance methodologies across extraterrestrial surfaces is disclosed, including but not limited to lunar surfaces, Martian surfaces, asteroidal surfaces, and/or surfaces of other celestial bodies where regolith or similar particulate surface materials exist.

### Gas Collection Methods and Systems

All systems, methods, and apparatuses for the collection of gases and/or isotopes released through mechanical disturbance of regolith are included, including but not limited to collection via adsorption, absorption, condensation, filtration, molecular sieving, membrane separation, cryogenic trapping, chemical binding, turbomolecular pumping, or combinations thereof.

Additionally, embodiments may include combinations of mechanical disturbance with supplementary or complementary gas liberation techniques, wherein mechanical disturbance serves as a primary, initial, or supporting mechanism for gas release. These methods may include localized or secondary thermal, electromagnetic, acoustic, or chemical treatment applied to regolith that has undergone mechanical disturbance.

### Selective Collection of Gases and Isotopes

Selective collection means for specific gases and/or isotopes of interest released through mechanical disturbance are encompassed. Gases such as helium (including He-3 and He-4), hydrogen, oxygen, nitrogen, carbon dioxide, water vapor, argon, neon, xenon, krypton, methane, and/or other volatiles present in extraterrestrial regolith are included.

Collection specificity may be achieved through various means, including but not limited to selective adsorption materials, selective membrane permeability, charge-based separation, size-based filtration, cryogenic separation, or combinations thereof, that preferentially capture gases and/or isotopes of interest over other gases or materials released through the mechanical disturbance.

### Optimization of Gas Collection Efficiency

Methods and systems for optimizing the efficiency, yield, selectivity, and/or energy consumption of gas and/or isotope collection through mechanical disturbance are disclosed. Optimization methods include, but are not limited to: adaptive control of disturbance depth, intensity, pattern, and/or speed; predictive targeting of regolith regions with higher gas and/or isotope concentrations; real-time adjustment of collection parameters based on detected gas release rates; and sequential or staged disturbance operations configured to maximize cumulative yield while minimizing energy expenditure.

All sensing, analysis, and control systems utilized to implement such optimization methods are encompassed, including but not limited to gas composition sensors, yield measurement systems, regolith characteristic sensors, and adaptive control algorithms that modify operational parameters based on collected data.

### Electrostatic Filtration and Mesh Filters

In certain embodiments, gas collection devices incorporate electrostatic filtering mechanisms to separate gases and isotopes from particulates. Mesh filters may include pore sizes between about 1 μm and about 1000 μm and may be constructed of electrically conductive materials resistant to the lunar environment, including but not limited to titanium alloys, nickel alloys, and/or metal-ceramic composites.

A charge application between about 1 V and about 500 V may be applied to the mesh filters, with charge polarities selectable according to specific collection operations, environmental conditions, and/or regolith characteristics encountered. Charge application may be pulsed to enhance regolith repulsion.

A multi-layer mesh configuration may be implemented, with increasing filtration precision from the mechanical agitator toward the gas collection chamber. The mesh layers may be spaced between about 0 cm and about 100 cm apart, with supports maintaining structural integrity.

Each mesh layer may be constructed from conductive material and may be operatively coupled to a charge control circuit. Voltage differentials between adjacent mesh layers may be applied to create electric fields that inhibit the passage of charged regolith particles while allowing neutral or oppositely charged gas and isotope molecules to pass.

A self-cleaning mesh system may be implemented, wherein charge reversal and vibrational cleaning mechanisms dislodge accumulated particles, which may then be collected in a designated receptacle.

### Hybrid Collection Approaches

In certain embodiments, selective gas separation techniques may be incorporated within the gas collection devices. These may include selectively permeable membranes positioned between the mesh filters and the gas collector that preferentially permit passage of gases and isotopes of interest (e.g., He-3, hydrogen, nitrogen) while limiting or preventing passage of less valuable gases. Gas concentration and purification methods may also be implemented, including but not limited to pressure swing adsorption, temperature swing adsorption, and/or cryogenic separation.

### Autonomous Optimization Based on Yield Data

Navigation controllers within the gas collection devices may include artificial intelligence circuits structured to adaptively optimize collection operations based on real-time yield data. Machine learning algorithms trained on datasets comprising collection yields, power consumption, and environmental parameters from prior collection operations may be implemented to predict optimal collection parameters. Predictive models may be continuously refined based on actual collection yields obtained from each collection operation.

### Integration With Lunar Infrastructure

The gas collection system may be interfaced with permanent lunar base facilities where support functions such as power recharging, storage of collected gases, maintenance operations, and/or remote command and control are provided.

A modular expansion system may be incorporated, allowing for additional collection units to be linked together in a coordinated configuration. Standardized mechanical, electrical, and data connections may be provided for integration into existing lunar infrastructure.

Electrostatic filtration techniques may also be implemented within lunar habitation modules for regolith management. Airlock transition chambers may be equipped with electrostatic containment fields to prevent regolith particles from entering habitation volumes. Electrostatic filters may further be incorporated into primary environmental control and life support systems to capture respirable regolith dust, reducing contamination risks.

### Thermal Management and Dust Mitigation

Thermal management systems may be configured to maintain operational temperatures for critical components during lunar day/night cycles, where surface temperatures range from approximately +120° C. to −170° C. Insulation layers, radiative cooling surfaces, resistive heating elements, and/or heat pipes may be utilized to regulate component temperatures.

Dust mitigation features may be structured to protect moving parts, optical sensors, and electronic components from the abrasive effects of lunar dust. Sealed bearings, protective sensor covers, electrostatic repulsion fields, and/or sacrificial wear surfaces may be incorporated. Vibrational cleaning mechanisms may also be implemented to periodically remove accumulated dust.

While the disclosure has been disclosed in connection with certain embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

What is claimed is:

1. A lunar surface gas collection system, comprising:
an agitation system to disturb the lunar surface and produce a plume of matter comprising gases and isotopes in a molecular flow regime;
a collection system to capture and contain the gases and isotopes and direct the gases and isotopes towards a secure collection area for capture; and
a solids prevention system to prevent a substantial amount of solids from the plume of matter from entering the collection system.

2. The lunar surface gas collection system of claim 1, wherein the collection system comprises a molecular directional change apparatus to change a momentum vector of at least some of the gasses and isotopes to substantially align with a path to the secure collection area.

3. The lunar surface gas collection apparatus of claim 2, wherein the molecular directional change apparatus is a turbomolecular pump.

4. The lunar surface gas collection apparatus of claim 2, wherein the path comprises a tortuous flow channel allowing a separation of gases and isotopes from other isotopes and gases from the plume of matter.

5. The lunar surface gas collection system of claim 1, wherein the solids prevention system comprises an electrostatic charge system charged with positive energy to repel the solids.

6. The lunar surface gas collection system of claim 5, wherein the electrostatic charge system comprises a mesh layer substantially covering an inlet of the collection apparatus.

7. The lunar surface gas collection system of claim 6, wherein the mesh layer comprises a plurality of mesh layers.

8. The lunar surface gas collection system of claim 7, wherein at least one of the plurality of mesh layers does not substantially cover the inlet.

9. A lunar surface gas collection system, comprising:
an agitation system to disturb the lunar surface and produce a plume of matter comprising
gasses and isotopes in a molecular flow regime; and
a collection system to prevent the spread of the gasses and isotopes and direct the gasses
and isotopes towards a secure collection area for capture through a tortuous flow channel allowing a separation of gasses and isotopes from other gases in the plume.

10. The lunar surface gas collection system of claim 9, further comprising a gasses and isotopes purification detector to measure the purity of the gas composition in at least one of the collection system, secure collection area, and tortuous flow channel.

11. A lunar surface gas collection system, comprising:
an agitation system to disturb the lunar surface and produce a plume of matter comprising gasses and isotopes in a molecular flow regime;
a collection system to contain the gasses and isotopes; and
a gas composition analyzer to measure the analyze the compensation of gasses and isotopes collected from the plume of matter.

12. The lunar surface gas collection system of claim 11, wherein the amount of gasses and isotopes is a determining factor in an autonomous movement system as to when to move the collection system to another position on the lunar surface for increased production of gasses and isotopes.

13. The lunar surface gas collection system of claim 11, wherein the amount of gasses and isotopes is a determining factor in an autonomous agitation control system as to when to cause the agitation system to dig further into the lunar surface for increased production of the gasses and isotopes.

14. (canceled)

15. (canceled)

16. (canceled)

17. (canceled)

18. (canceled)

19. (canceled)
